(19) United States
(12) Patent Application Publication
(10) Pub. No.: US 2012/0168536 A1
(43) Pub. Date: Jul. 5, 2012

(54) FLEXIBLE TUBE FOR IRRIGATING TREES

(76) Inventor: DARRELL K. DOWNEY, CANTON, GA (US)

(21) Appl. No.: 12/983,286

(22) Filed: Dec. 31, 2010

(51) Int. Cl. A01G 27/06; B05B 15/00

(52) U.S. Cl. 239/547

(57) ABSTRACT

A device for watering vegetation, such as a tree, has a flexible tube that can be laid flat and rolled up. The flexible tube has a watertight seal about 2 inches to about 6 inches from each end, which leaves a flap at each end. The flexible tube is placed in a circular configuration around the tree, and its flaps are joined together with hook and loop fasteners. There are one or two openings along the length of the tube through which water can be admitted into the flexible tube. At or near the bottom of the flexible tube is at least one pre-filtered drip emitter from which water can leave the flexible tube at a controlled flow rate.

### FIELD OF THE INVENTION

This invention relates to irrigation devices, and particularly to hydro-inflatable irrigation devices for watering vegetation.

### BACKGROUND OF INVENTION

Hundreds of millions of dollars are spent on trees and other plantings for landscaping, commercial growing, and home gardening. Countless hours of labor are invested to water-in these plantings, until the planting establishes an extended root system. Despite these efforts, millions of dollars are spent replacing trees and other plantings due to improper watering during the root establishment period.

Most forms of vegetation, when established in a landscape, have moisture supplying roots that penetrate the soil for significant distances. For example, many forms of fully established trees are known to have root systems that extend radially outward from the base of the trunk, well beyond the drip line of the tree's leaf canopy. For this reason, even a light rainfall supplies a significant amount of water to an established plant.

Trees, shrubs, and other forms of vegetation, are commercially supplied with their roots tightly concentrated into a relatively small diameter, soil filled plastic container or a ball that is held together with a fabric wrap, most commonly burlap. When the plant is removed from the container and is planted in the soil, a light rainfall supplies very little water to the plant, relative to an identical plant with an established (extended) root system. For this reason, many plantings fail to survive even in periods of normal rainfall without substantial efforts to provide supplemental watering. A drought further heightens the need to supply supplemental watering. Also, if people go on vacation or are going to be away for some time, they may wish to be sure that their plant has adequate water while they are away, rather than risk losing costly plants. In many cases, people desire to install plantings in remote locations, such as a vacation home, or even the center median of a highway, but are unable to do so because of the costs or efforts required to supply supplemental water to the new planting during the critical period of root extension and establishment.

A number of devices have been invented that can be placed around trees or other plants and filled with water. The devices slowly let the water leak out into the ground. Some of these devices are expensive to make, however, or are not versatile enough to be used for a variety of different applications.

For example, U.S. Pat. No. 6,108,970 shows a self-watering plant guard that can be placed around a tree. It is filled with water and slowly lets the water out through a water release outlet in the base. Stakes are used to secure it. However, the devise has numerous internal compartments and would be expensive and difficult to make. Further, because of the formation of these multiple compartments to create and sustain vertical rigidity, the capacity for holding water is significantly reduced. Lastly, because of the device's installed height, it is not adaptable to trees and other plantings that have low hanging branches (example: conifers).

U.S. Pat. No. 5,117,582 shows a drip irrigator that is fitted around a tree and is filled with water which percolates out through multiple openings in the bottom. It has a removable cap at the top for filling. It is made in a C-shape, which keeps the holes at the bottom and the cap at the top. This device uses the trunk of the tree to hold it in place. In plantings that are not perfectly vertical, it places a substantial horizontal component of force upon the trunk of the tree when filled with water. Further, because the device comes into contact with the trunk of the tree, there is no air circulation, which promotes the formation of mildew and trunk discoloration. The device is not adaptable to plants having low hanging branches and is not adaptable to multi-trunk trees and shrubs. The method of administering water from the bottom of the device (a series of orifices) is prone to plugging from dirty water. In a commercial application, the device releases the full contents of its reservoir in a period of six to ten (6-10) hours.

In U.S. Pat. No. 7,082,716, Downey teaches a similar device with similar drawbacks.

### SUMMARY OF INVENTION

The watering device of this invention is a flexible tube that can be flattened and rolled up for storage, or ease of transporting. The flexible tube is sealed a short distance from each end, and the portion of the tube that extends beyond the seals are attachable one to the other with hook and loop fastener, so that the tube, when filled with water, will remain in an upright position. There are one or two openings in the top of the tube for filling it with water and numerous pre-filtering drip emitters in the bottom through which the water gradually leaks out into the soil around a plant. There are no internal compartments or reinforcements on the tube, making it simple and inexpensive to manufacture. Because of the flexibility of the design, large quantities of water may be retained and administered over extended periods of time, from one day to one month.

A general aspect of the invention is a device for providing water to vegetation, the device comprising: a length of lay-flat flexible tube having two ends and two opposing inside surfaces, the two opposing inside surfaces remaining separate until about 2 to 6 inches from each end of the flexible tube, whereupon a watertight seal extending across the tube at each end forms a compartment inside the flexible tube, also leaving an end-flap at each end of the flexible tube that is about 2 to 6 inches long; hook and loop fasteners attached to the end-flaps, respectively, such that when the end-flaps of the flexible tube are joined together, the flexible tube can be filled with water and remain in a stable circular position, with the bottom of the flexible tube substantially contacting the ground surface; at least one opening into the compartment, the at least one opening being able to admit water into the compartment; and at least one pre-filtering drip emitter extending out through an inside surface of the compartment, the water being able to exit the flexible tube therethrough.

In a preferred embodiment, when the flexible tube is filled with water, the flexible tube assumes a cross-sectional shape that is wider than it is high.

In a preferred embodiment, when the flexible tube is empty, it may be laid flat and rolled up.

In a preferred embodiment, the at least one opening into the compartment is at least near a watertight seal.

In a preferred embodiment, the at least one pre-filtering drip emitter extends out through an inside surface of the compartment near the bottom of the flexible tube.

In a preferred embodiment, the flexible tube is made of low-density polyethylene.

In a preferred embodiment, the opening is sealable using a removable cap.

In a preferred embodiment, the pre-filtering emitter includes water wicking material tightly encased in shrink-tubing.

In a preferred embodiment, the flexible tube is about 6 to about 14 inches in diameter.

In a preferred embodiment, the flexible tube is about 2 feet to about 36 feet long.

In a preferred embodiment, the flexible tube is colored to prevent the growth of algae.

In a preferred embodiment, a single tube is formed into a circle by joining both ends of the flexible tube using hook and loop fasteners.

In a preferred embodiment, the tube can be rolled up.

Another general aspect of the invention is a device for providing water to vegetation, the device comprising: a length of flexible tube having two sealed ends, the sealed ends forming a water-fillable compartment inside the flexible tube; at least one opening into the compartment, the at least one opening being able to admit water into the compartment; and at least one pre-filtering drip emitter extending out through an inside surface of the water-fillable compartment, the water being able to exit the flexible tube through the at least one pre-filtering drip emitter.

In a preferred embodiment, the device further includes: hook and loop fasteners attached the sealed ends, respectively, such that when the sealed ends of the flexible tube are joined together, the flexible tube can be filled with water and remain in a stable circular position, with the bottom of the flexible tube substantially contacting the ground surface.

In a preferred embodiment, the at least one pre-filtering drip emitter includes: wicking material; and heat-shrink tubing constrictingly surrounding the wicking material.

In a further preferred embodiment, flow rate out of the flexible tube is determined by determining length of the heat-shrink tubing surrounding the wicking material.

In a further preferred embodiment, flow rate out of the flexible tube is determined by choice of wicking material properties, such as: weave density; strand diameter; and/or strand material.

In a further preferred embodiment, flow rate out of the flexible tube is determined by choice of wall thickness of the heat-shrink tubing.

### BRIEF DESCRIPTION OF DRAWINGS

The invention will be more fully understood by reference to the detailed description, in conjunction with the following figures, wherein:

FIG. 1. is a side view of the device unfilled with water, and before tree encirclement;

FIG. 2. is a top view of device filled with water and encircling a tree;

FIG. 3. is a side cutaway view of section A-a of FIG. 2;

FIG. 4. is a side view of the device filled with water;

FIG. 5. is a perspective view of the unfilled device rolled up;

FIG. 6. is a top view of the device with a re-closeable fill opening;

FIG. 7. is a side view of wicking material inserted through unshrunk tubing;

FIG. 8. is a side view of wicking material inserted through shrunk tubing;

FIG. 9. is a side view of wicking material inserted through a fitment and secured in place with shrink tubing; and

FIG. 10. is a top view of the device with multiple pre-filtering drip emitters.

### DETAILED DESCRIPTION

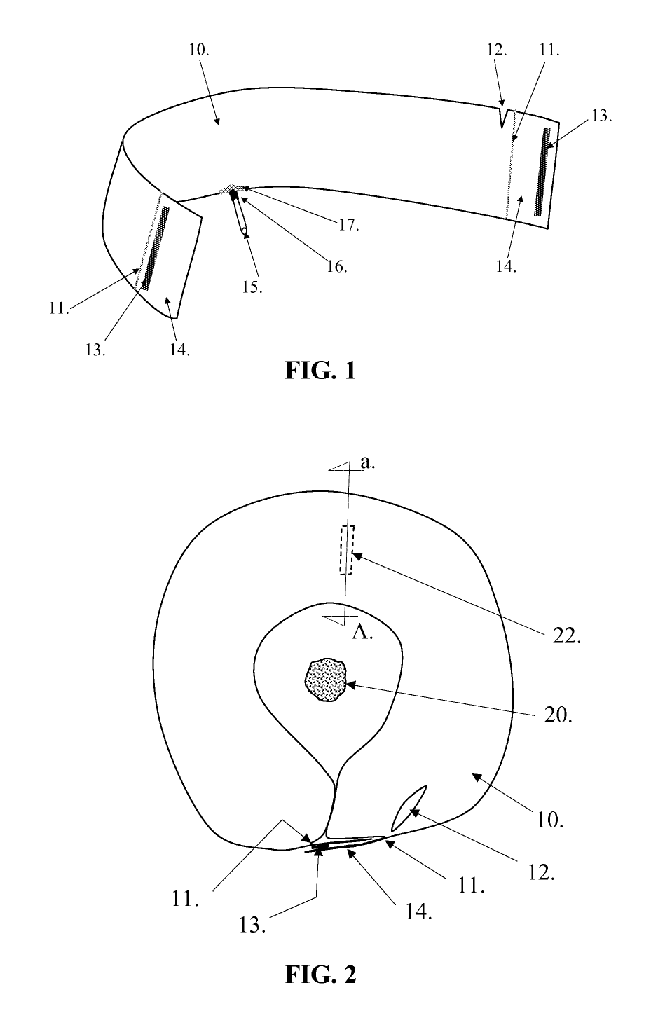

Turning to the drawings in greater detail, FIG. 1 is cylindrical watering tube 10 made of lay flat tubing. Watertight seals 11 are formed across the full width of tube 10 perpendicular to the longitudinal axis of the tube 10. Seals 11 are made inwards from each end to create flaps 14. Hook and loop fasteners 13 are attached to flaps 14 so that when hook and loop fasteners 13 are joined together, the cylindrical watering tube 10 forms a circular shape. An opening 12 is created on the top of tube 10 near watertight seal 11 to allow filling tube 10 with water. Wicking material 15 is inserted through (pre) heat shrink tubing 16. Heat is applied to shrink tubing 16 causing it to decrease in diameter and tightly compress wicking material 15. Wicking material 15 and post shrink tubing 16 are inserted through slit in the bottom of cylindrical watering tube 10 and secured with watertight seal 17.

In FIG. 2, cylindrical watering tube 10 encircles a tree 20. End flaps 14 are secured together with hook and loop fasteners 13. Tube 10 is filled with water through opening 12. Water slowly exits tube 10 through wicking assembly 22.

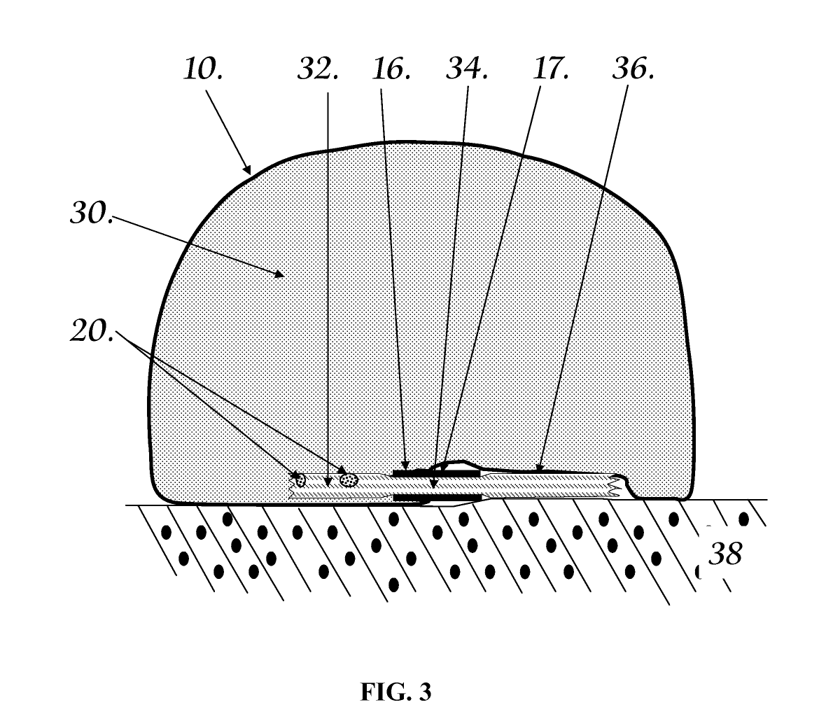

In FIG. 3, the cross section Aa of FIG. 2 is shown. Cylindrical watering tube 10 is filled with water 30. Water 30 enters uncompressed wicking material 32. Contaminates 20 are filtered by wicking material 32. Clean water 34 continues through tightly compressed wicking material 34 where the flow rate of water 34 is controlled. As water enters uncompressed wicking material 36 it is transferred to the ground 38. The weight of the water 30 filled tube 10 firmly presses the uncompressed wick material 36 against the ground 38 facilitating the wick 36 to ground 38 transfer and shields the wick 36 from ultraviolet degradation.

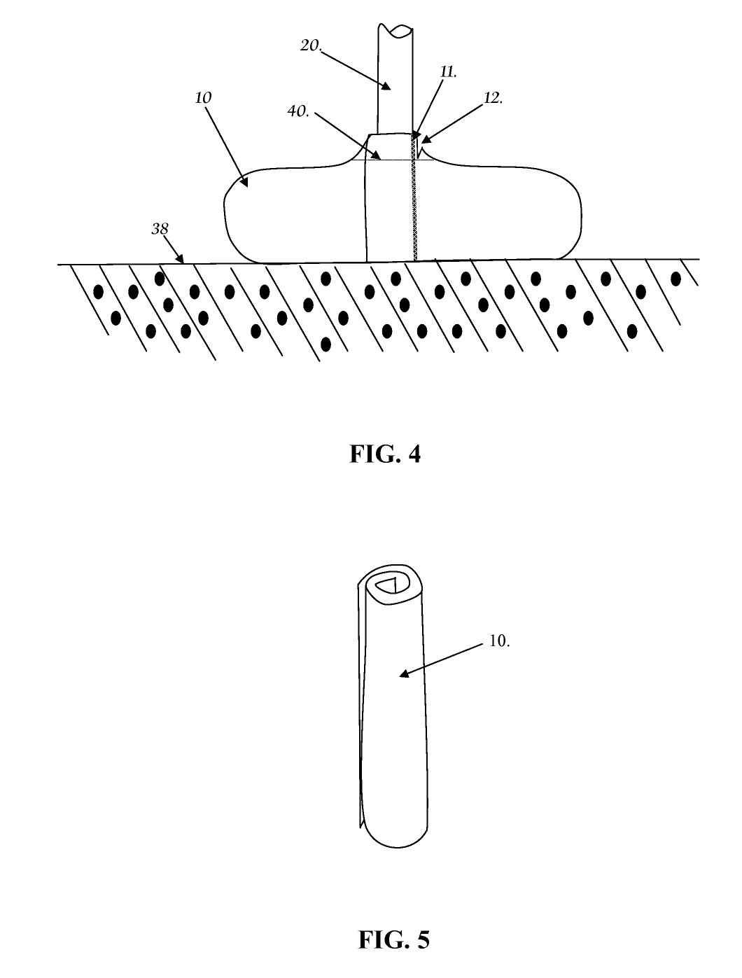

In FIG. 4, cylindrical watering tube 10 is shown installed around a tree 20 and filled with water to a level 40.

In FIG. 5, cylindrical watering tube 10 is shown rolled up for transport or storage.

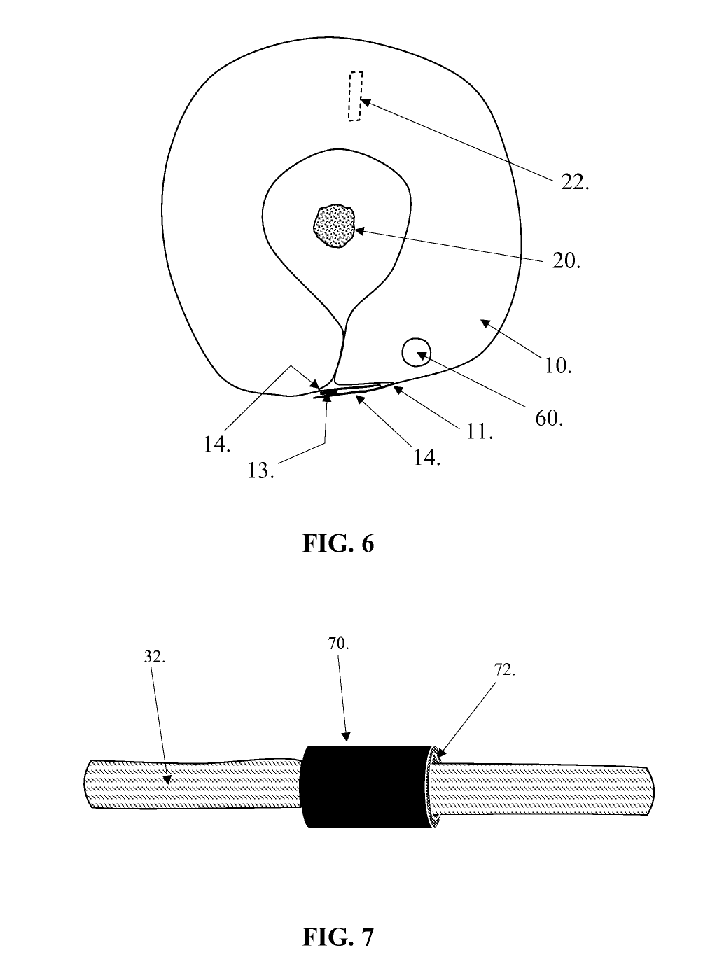

In FIG. 6, cylindrical watering tube 10 is shown with closable fill cap 60.

In FIG. 7, wicking material 32 is shown being passed through heat shrink tubing 70. Since heat has not been applied to shrink tubing 70 adequate clearance 72 exists for assembly.

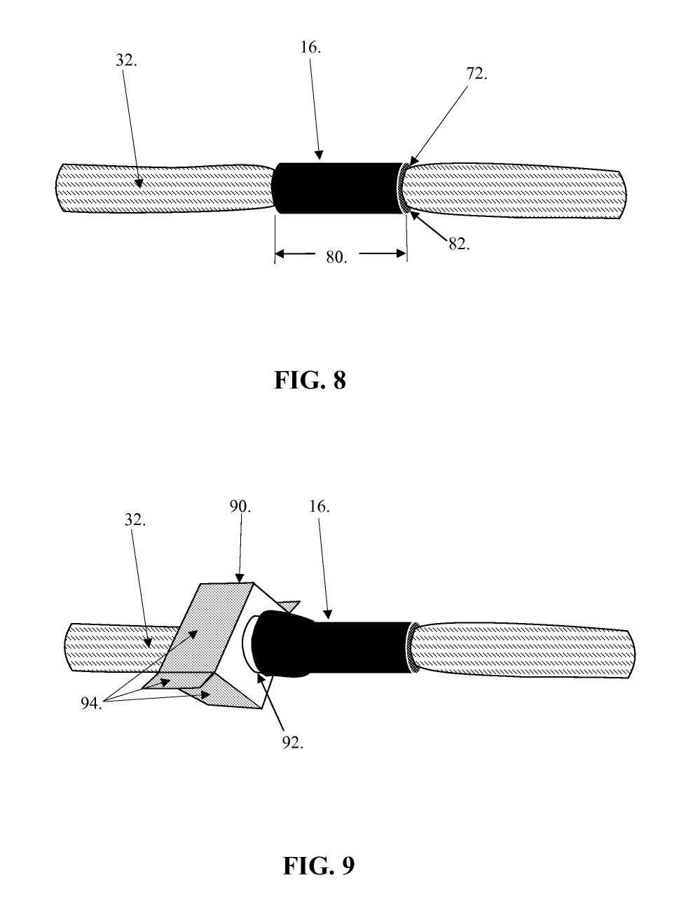

In FIG. 8, heat is applied to shrink tubing 16 causing tubing 16 to remove clearance 72 between tubing 16 and wicking material 32. By varying the length 80 of the heat shrink tubing 16 which constricts wicking material 32 different flow rates are prescribed. Increasing wall thickness 82 of shrink tubing 16 and changing wick material 32 properties (weave density, strand diameter, strand material) further enables control of flow rate as required for various applications.

In FIG. 9, fitment 90 is shown to enable in field replacement of the wicking material. Fitment 90 includes a neck 92 that has an inside diameter greater than the outside diameter of wicking material 32 and an outside diameter with male threads. Wick material 32 is inserted through neck 92 of fitment 90 and pre shrink tubing 16 is passed over wick material 32 and the male threads on neck 92. Heat is applied to shrink tubing 16 to secure wick assembly to neck 92 and constrict wick material 32. Sealing surface 94 along outer periphery of fitment 90 is heat sealed into cylindrical watering tube 10 with fitment neck 92 exposed on the outer side of tube 10.

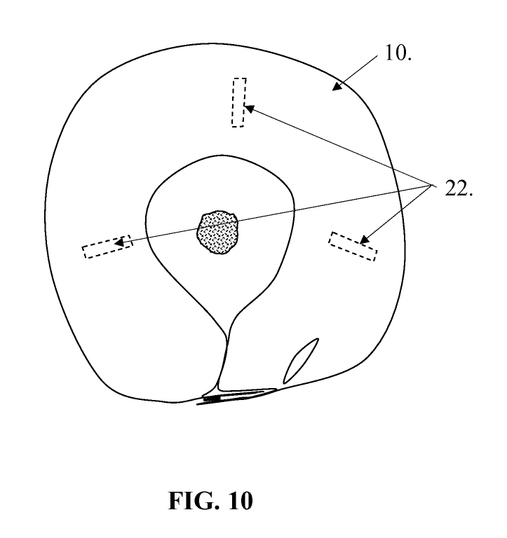

In FIG. 10, cylindrical watering tube 10 is shown with multiple wicking assemblies 22 as may be prescribed for certain conditions.

Other modifications and implementations will occur to those skilled in the art without departing from the spirit and the scope of the invention as claimed. Accordingly, the above description is not intended to limit the invention, except as indicated in the following claims.

What is claimed is:

1. A device for providing water to vegetation, the device comprising:
a length of lay-flat flexible tube having two ends and two opposing inside surfaces, the two opposing inside surfaces remaining separate until about 2 to 6 inches from each end of the flexible tube, whereupon a watertight seal extending across the tube at each end forms a compartment inside the flexible tube, also leaving an end-flap at each end of the flexible tube that is about 2 to 6 inches long;
hook and loop fasteners attached to the end-flaps, respectively, such that when the end-flaps of the flexible tube are joined together, the flexible tube can be filled with water and remain in a stable circular position, with the bottom of the flexible tube substantially contacting the ground surface;
at least one opening into the compartment, the at least one opening being able to admit water into the compartment; and
at least one pre-filtering drip emitter extending out through an inside surface of the compartment, the water being able to exit the flexible tube therethrough.

2. The device of claim 1, wherein when the flexible tube is filled with water, the flexible tube assumes a cross-sectional shape that is wider than it is high.

3. The device of claim 1, wherein when the flexible tube is empty, it may be laid flat and rolled up.

4. The device of claim 1, wherein the at least one opening into the compartment is at least near a watertight seal.

5. The device of claim 1, wherein the at least one pre-filtering drip emitter extends out through an inside surface of the compartment near the bottom of the flexible tube.

6. The device of claim 1, wherein the flexible tube is made of low-density polyethylene.

7. The device of claim 1, wherein the opening is sealable using a removable cap.

8. The device of claim 1, wherein the pre-filtering emitter includes water wicking material tightly encased in shrink-tubing.

9. The device of claim 1, wherein the flexible tube is about 6 to about 14 inches in diameter.

10. The device of claim 1, wherein the flexible tube is about 2 feet to about 36 feet long.

11. The device of claim 1, wherein the flexible tube is colored to prevent the growth of algae.

12. The device of claim 1, wherein a single tube is formed into a circle by joining both ends of the flexible tube using hook and loop fasteners.

13. The device of claim 1, wherein the tube is rolled up.

14. A device for providing water to vegetation, the device comprising:
a length of flexible tube having two sealed ends, the sealed ends forming a water-fillable compartment inside the flexible tube;
at least one opening into the compartment, the at least one opening being able to admit water into the compartment; and
at least one pre-filtering drip emitter extending out through an inside surface of the water-fillable compartment, the water being able to exit the flexible tube through the at least one pre-filtering drip emitter.

15. The device of claim 14, further comprising:
hook and loop fasteners attached the sealed ends, respectively, such that when the sealed ends of the flexible tube are joined together, the flexible tube can be filled with water and remain in a stable circular position, with the bottom of the flexible tube substantially contacting the ground surface.

16. The device of claim 14, wherein the at least one pre-filtering drip emitter includes:
wicking material; and
heat-shrink tubing constrictingly surrounding the wicking material.

17. The device of claim 16, wherein flow rate out of the flexible tube is determined by determining length of the heat-shrink tubing surrounding the wicking material.

18. The device of claim 16, wherein flow rate out of the flexible tube is determined by choice of wicking material properties, such as:
weave density; strand diameter; and/or strand material.

19. The device of claim 16, wherein flow rate out of the flexible tube is determined by choice of wall thickness of the heat-shrink tubing.
